(19) United States
(12) Patent Application Publication
(10) Pub. No.: US 2002/0123447 A1
(43) Pub. Date: Sep. 5, 2002

(54) Layered silicate built laundry detergent composition

(76) Inventors: Scott D. Manske, Davidson, NC (US); Arshad Hussain Malik, Dublin, CA (US)

Correspondence Address: CLARIANT CORPORATION, INTELLECTUAL PROPERTY DEPARTMENT, 4000 MONROE ROAD, CHARLOTTE, NC, 28205, US

(21) Appl. No.: 09/751,443

(22) Filed: Dec. 29, 2000

(51) Int. Cl. C11D 7/18

(52) U.S. Cl. 510/377; 510/477; 510/508; 510/509

(57) ABSTRACT

A non-phosphate based laundry detergent composition built primarily by layered silicate and secondarily by carbonate and/or bicarbonate salt, one or more polycarboxylates or polycarboxylic acids, and optionally small amounts of zeolite. The disclosed composition produces remarkably low levels of hard water induced encrustation while providing good detergency. The detergent composition includes a layered silicate, one or more surfactants, carbonate and/or bicarbonate salt, one or more polycarboxylates or polycarboxylic acids, additional inorganic salts, and optionally a zeolite. The detergent composition may further include additional conventional constituents, including but not limited to fragrances, enzymes, optical brighteners, bleaching agents, wrinkle reduction agents, anti-foam agents, soil release agents, disintegration agents and soil anti-redeposition agents. The form of the final composition may either be a tablet or a powder. The bulk density of the powder may range from about 200 to about 1000 gpl depending on the raw materials used and the processing approach employed.

### FIELD OF THE INVENTION

The present invention relates generally to laundry detergent compositions and, more particularly, to layered silicate built laundry detergent systems that exhibit good detergency while minimizing hard-water induced encrustation.

### BACKGROUND OF THE INVENTION

Laundry detergent products, when used properly, are expected to provide effective cleaning of soiled substrates without inordinately contributing to the visual or tactile degradation of the garment. A detergent composition that fails to provide effective cleaning is a poor product. Likewise, a detergent product that provides effective soil removal but directly leads to graying of white garments or fading of colored garments, thereby effectively reducing the functional lifespan of garments, is also a poor product. Therefore, a product which incurs excessive deposition of insoluble inorganic salts onto garments, a phenomena known as encrustation or alternately ashing, is a poor product.

Detergent builders are substances that enhance the detersive effects of surfactants, which are the main detersive components in a detergent, by removing hardness ions from the wash liquor. Unbuilt hardness ions are undesirable for several reasons: 1) unbuilt hardness ions may complex with anionic surfactants thereby reducing the detersive effectiveness of the surfactant; 2) unbuilt hardness ions may interact with substrate-bound soils and the respective substrate to reduce the electrostatic repulsion between the soil and substrate thereby hindering the detersive process; and, 3) unbuilt hardness ions may complex with anions in situ to form insoluble precipitates that deposit on fabric and machines.

Detergent compositions that are built primarily by precipitative builders, such as sodium carbonate or sodium bicarbonate, are prevalent in the detergents marketplace and are well known in the art. Despite the fact that laundry detergents containing significant amounts of carbonate builders are generally considered to be effective in cleaning a broad class of fabrics, under many conditions the use of high concentrations of carbonate builders can give rise to problems, such as a faded appearance of colored fabrics and a tactilely stiff hand. These undesirable outcomes are the result of a phenomenon known to those skilled in the art as encrustation or ashing. Encrustation refers to the deposition of insoluble inorganic calcium or magnesium salts (e.g., calcium carbonate or magnesium carbonate) that occurs in each individual wash and builds up over multiple washes of a garment leaving that garment looking dingy or faded. Prevention or significant reduction of encrustation is a highly desirable feature of a laundry detergent because excessive encrustation can significantly reduce the effective lifespan of garments. Therefore, significant amount of work has been devoted to investigating ways to prevent encrustation while providing cost-effective cleaning.

Non-precipitative builders such as phosphates (e.g., pentasodium tripolyphosphate) and zeolites (aluminasilicates) are cost-effective builder alternatives that have been used extensively as primary detergent builders and typically do not directly contribute to fabric encrustation. However, each of these materials has negative attributes associated with its use as a main detergent builder in detergent products.

Detergent phosphates are strong sequestering agents that bind both calcium and magnesium effectively and efficiently. Such phosphates are a good source of alkalinity and are effective soil suspending agents. U.S. Pat. Nos. 4,473,485, 4,521,323, 4,521,332, 4,711,740, 4,820,441, 4,849,125, 5,152,910, and 5,552,078 each disclose the use of some form of a phosphate ingredient as a detergent builder in laundry compositions. However, phosphates have been linked to environmental negatives and the use of the same in laundry products has been greatly reduced due to restrictive legislation. In fact, phosphate use in household laundry detergent products has been banned in many U.S. States and is nearly nonexistent at present throughout the United States of America.

Zeolites, though not nearly as cost-effective as phosphates, have been shown to be effective builders when used in combination with alkalinity agents, co-builders and soil suspension/antiredeposition agents. U.S. Pat. No. 5,393,455 teaches the use of high levels of zeolites in detergent compositions. Unfortunately, zeolites are insoluble and their use results in the gradual accumulation of wastewater sludge. Zeolites, being insoluble, can themselves cause color fading by depositing onto garments. Additionally, zeolites do not effectively bind magnesium hardness ions or contribute to alkalinity which is important for saponifying acidic constituents of soil and for dispersing and suspending soils.

These major issues associated with phosphates and zeolites have contributed to the development of an alternate detergent builder, crystalline-layered silicate (i.e., layered silicates). Layered silicates are effective builders which bind both calcium and magnesium ions while being a ready source of alkalinity. Unlike zeolites, layered silicates are completely soluble and therefore do not contribute to wastewater sludge accumulation. Unlike phosphates, layered silicates are not associated with environmental negatives and are not the subject of restrictive legislation.

U.S. Pat. Nos. 5,393,455 and 5,900,399 disclose a use of crystalline-layered silicates. U.S. Pat. No. 5,393,455 (′455″) discloses a phospate-free builder composition having from 60 to 96% by weight of zeolite, from 2 to 16% by weight of polymeric polycarboxylate, and from 2 to 25% by weight of crystalline layer silicate corresponding to the formula NaMSiₓO₂ₓ₊₁.yH₂O, wherein M is sodium or hydrogen, x is a number of 1.9 to 4 and y is a number of 0 to 20. The use of high quantities of zeolite, as disclosed by ′455, directly infers a high level of insoluble materials which could contribute to color fading due to deposition on garments as well as resulting in wastewater sludge accumulation as previously mentioned.

U.S. Pat. No. 5,900,399 (′399″) discloses a tablet composition having 2 to 80% by weight of a mixture of x-ray amorphous silicates and crystalline layer-form sodium silicates corresponding to the formula Na₂SiₓO₂ₓ₊₁.yH₂O, wherein x is a number of 1.0 to 4 and y is a number of 0 to 20, and 5 to 80% by weight of water-containing zeolite or phosphate, wherein the silicates are present in a ratio by weight of 10:1 to 1:10. The tablet composition of ′399 only contains water in a quantity such that the maximum theoretical water-binding capacity of the component is not exceeded. The ′399 tablet composition requires not only partly crystalline and/or crystalline layer-form sodium silicates but also amorphous silicates. Amorphous silicates are an intregal component of the ′399 tablet composition.

What is therefore needed is a non-phosphate based laundry detergent composition that minimizes the encrustation commonly associated with the use of conventional carbonate built detergents while providing good detergency. More particularly, what is needed is a phosphate free laundry detergent composition that does not substantially contribute to waste stream sludge accumulation while providing effective detergency.

### SUMMARY OF THE INVENTION

The present invention is a layered silicate based laundry detergent composition. The detergent builder composition is based primarily on layered silicate and secondarily on sodium carbonate and/or sodium bicarbonate, one or more polycarboxylates, and optionally a small amount of zeolite. The composition produces remarkably low levels of hard water induced encrustation while providing good detergency. Encrustation or ashing refers to the deposition of insoluble inorganic calcium or magnesium salts (e.g., calcium or magnesium carbonate) that occurs in each individual wash and builds up over multiple washes of a garment leaving that garment looking dingy or faded. Prevention or significant reduction of encrustation is a highly desirable feature of a laundry detergent as excessive encrustation can significantly reduce the effective lifespan of garments. The invented detergent composition can be either in the form of a powder or a tablet.

The invented detergent composition includes layered silicate, one or more surfactants, carbonate and/or bicarbonate salts, one or more polycarboxylates or polycarboxylic acids, additional inorganic salts, and optionally a small amount of zeolite. The invented composition may further include additional conventional constituents, including but not limited to fragrances, enzymes, optical brighteners, bleaching agents, wrinkle reduction agents, anti-foam agents, soil release agents, disintegration agents and soil anti-redeposition agents. The detergent composition may take the product form of a tablet or a powder, alternatively referred to as an agglomerate or granulate. Furthermore, depending upon the exact nature of the materials used in the composition and the way the composition is processed, the powder can exhibit a wide range of bulk densities ranging from a conventional, low density (i.e., 200-400 gpl bulk density) product to a compact, high density (i.e., 800-1000 gpl bulk density) product.

The detergent composition includes a significant amount of precipitative builder (i.e., carbonate and/or bicarbonate salt) as a secondary builder and yet produces surprisingly low levels of hard water induced encrustation. The level of encrustation incurred, as measured by black fabric color fading, is similar to detergent systems lacking a precipitative builder.

### DETAILED DESCRIPTION OF THE INVENTION

The present invention is a layered silicate, non-phosphate based laundry detergent composition that is built primarily by layered silicate and secondarily by carbonate and/or bicarbonate salt, one or more polycarboxylate or polycarboxylic acid, and optionally a small amount of zeolite. In one embodiment, the present invention is a detergent composition that includes a layered silicate, one or more surfactants, carbonate and/or bicarbonate salt, one or more polycarboxylates or polycarboxylic acids, additional inorganic salts, and optionally a zeolite. The product form may be either a tablet or a powder.

The surfactants may be anionic and/or nonionic. Any anionic surfactant useful for detersive purposes is suitable. These can include salts (including, for example, sodium, potassium, ammonium, and substituted ammonium salts such as mono-, di- and triethanolamine salts) of an anionic sulfate, sulfonate and/or carboxylate. Anionic sulfonate or sulfate surfactants are preferred.

Anionic sulfonate surfactants suitable for use herein include the salts of C₅-C₂₀ linear alkylbenzene sulfonates, alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof.

Anionic sulfate surfactants suitable for use in the compositions of the invention include linear and branched primary and secondary alkyl sulfates, alkyl ethoxysulfates, fatty oleoyl glycerol sulfates, alkyl phenol ethylene oxide ether sulfates, C₅-C₁₇ acyl-N—(C₁-C₄ alkyl) and —N—(C₁-C₂ hydroxyalkyl)glucamine sulfates, and sulfates of alkylpolysaccharides, such as sulfates of alkylpolyglucoside (the nonionic nonsulfated compounds being described herein).

Suitable anionic carboxylate surfactants include alkyl ethoxy carboxylates, alkyl polyethoxy polycarboxylate surfactants and soaps (“alkyl carboxyls”).

An example of a preferred anionic surfactant would be the sodium salt of secondary alkane sulfonate commercially available under the tradename of Hostapur® SAS (Clariant Corporation, Charlotte, N.C.).

Any nonionic surfactant useful for detersive purposes is suitable. The ethoxylated and propoxylated alcohol based nonionic surfactants are preferred. Both linear or branched alkoxylated groups are suitable.

Preferred alkoxylated surfactants can be selected from the classes of nonionic condensates of alkyl phenols, nonionic ethoxylated alcohols, nonionic ethoxylated/propoxylated fatty alcohols, nonionic ethoxylate/propoxylate condensates with propylene glycol, and nonionic ethoxylate condensation products with propylene oxide/ethylene diamine adducts. An example of a preferred nonionic surfactant would be the natural alcohol derived C₁₂-C₁₆ alcohol ethoxylates with an average of about 9 moles of ethylene oxide offered commercially under the tradename of Genapol® 26 L 80 (Clariant Corporation, Charlotte, N.C.). A second example of a preferred nonionic surfactant would be the natural alcohol derived C₁₂-C₁₆ alcohol ethoxylates with an average of about 7.3 moles of ethylene oxide offered commercially under the tradename of Genapol® 26 L 60 (Clariant Corporation, Charlotte, N.C.).

Crystalline layer-form sodium silicates suitable for the present invention have the general formula NaMSiₓO₂ₓ₊₁.yH₂O, where M is sodium or hydrogen, x is a number from about 1.0 to about 4 and y is a number from 0 to about 20. Preferred crystalline layer silicates are those in which M is sodium and x assumes a value of 2 or 3. Both β- and δ-sodium disilicates Na₂Si₂O₅yH₂O are particularly preferred. The most preferred layered silicate is the δ-sodium disilicate and is commercially available under the tradename of SKS 6® (Clariant Corporation, Charlotte, N.C.).

Polycarboxylates suitable for the present invention include but are not limited to acrylate and/or maleate homo-polymers or co-polymers. Suitable polymers may range in average molecular weight from about 2,000 to about 100,000.

Natural and synthetic zeolites may be used in the invented composition. Examples of natural zeolites include but are not limited to chabazite, mordenite, erionite, faujasite, clinoptilolite, and phillipsite. Examples of synthetic zeolites include but are not limited to zeolite A, zeolite X, zeolite Y, zeolite L, zeolite P, zeolite omega and ZSM-5.

Suitable composition quantities of the constituents of this invention include from about 5 to about 40% by weight of surfactant or surfactant mixture, from about 10 to about 50% by weight of a layered silicate, from about 0 to about 10% by weight of zeolite, from about 5% to about 30% by weight of carbonate and/or bicarbonate salt, from about 1 to about 15% by weight of one of more polycarboxylates or polycarboxylic acids , and from about 0 to about 70% by weight of filler materials such as additional inorganic salts. A preferred composition of this invention includes from about 5 to about 30% by weight of surfactant or surfactant mixture, from about 20 to about 40% by weight of a layered silicate, from about 0 to about 5% by weight of zeolite, from about 5% to about 20% by weight of carbonate and/or bicarbonate salt, from about 1 to about 10% by weight of one or more polycarboxylates or polycarboxylic acids, and from about 0 to about 70% by weight of filler materials such as additional inorganic salts. The invented composition may further include additional conventional constituents such as soil-releasing compounds, soil redeposition inhibitors, foam inhibitors, bleaching agents, wrinkle reduction agents, fragrances, colorants or dyes, enzymes, optical brighteners, and disintegration agents. The amounts of such additional agents are those commonly used in laundry products and are familiar to those skilled in the art.

Examples of soil redeposition inhibitors include but are not limited to polymeric carboxylic acids or the water soluble salts thereof, ether carboxylic acids or ether sulfonic acids of starch or cellulose or the salts thereof or sulfuric acid esters of cellulose or starch or the salts thereof, water-soluble polyamides containing acidic groups, soluble starch preparations, and polyvinyl pyrrolidone. A preferred redeposition inhibitor is a low average molecular weight (e.g., 3,500-10,000) homo-polymer of acrylic acid. An example of a preferred redeposition inhibitor is a 4,500 average molecular weight acrylic acid homo-polymer commercially available under the tradename Accusol® 445 (Rohm & Haas Corporation, Philadelphia, Pa.).

Examples of foam inhibitors include but are not limited to natural or synthetic soaps with a high percentage content of C₁₈₋₂₄ fatty acids, organopolysiloxanes and mixtures thereof with silanized silica, paraffins, and waxes. An example of a foam inhibitor is Dow Corning 1510 Silicone Antifoam (Dow Corning Corporation, Midland, Mich.).

Examples of enzymes include but are not limited to proteases, lipases, amylases, cellulases and mixtures thereof. . An example of an alkaline lipase enzyme is Lipolase 100LT (Novo Nordisk BioChem North America, Franklinton, N.C.).

Examples of optical brighteners include but are not limited to derivatives of diaminostilbene disulfonic acid or alkali metal salts thereof. An example of a preferred optical brightener is the commercially available material Leucophor® BSB (Clariant Corporation, Charlotte, N.C.).

Examples of bleaching agents include but are not limited to inorganic peroxygen liberating agents including sodium perborate and sodium percarbonate, peroxygen activators (or peroxyacid precursors) including tetra acetylethylenediamine (TAED) and nonanoyl oxybenzene sulfonate (NOBS), and peroxyacids including pthalimidoperhexanoic acid (PAP). An example of a preferred bleaching system would be a 3:1 weight ratio of sodium perborate monohydrate and the bleach activator TAED commercially available under the tradename of Peractive® AN (Clariant Corporation, Charlotte, N.C.).

Examples of disintegration agents include but are not limited to readily water soluble materials, such as sodium acetate, effervescent materials, such as bicarbonate salt in combination with an organic acid (e.g., citric acid), and readily water swellable materials such as starches, cellulosics, and specialty polymers such as some polycarboxylates and polyvinylpyrrolidone (PVP). An example of a preferred disintegration agent is the specialty polycarboxylate commercially available under the tradename Accusol 771 (Rohm & Haas Corporation, Philadelphia, Pa.).

### EXAMPLES

Encrustation experiments were conducted in Tergotometers. Black cotton t-shirts cut into 4″×6″ swatches (4 swatches per tergotometer pot) were included as encrustation receptor substrates. The cloths were washed 5 consecutive cycles for 15 minutes each wash. The wash water was held at 100 degrees Fahrenheit, and the water hardness was 300 ppm (3:1 Ca:Mg). The conditions used in this procedure were purposefully chosen as representative of approaching worst-case in-field conditions. The test is an accelerated laboratory procedure and is typical of those used throughout the industry. The formulations were each dosed at 1.5 grams per liter. Prewash and postwash reflectance measurements (L*a*b* CIE scale) were made on the swatches. The change in blackness (delta B=L−3 b) was calculated, and the average value is reported in Tables 1 and 2. A smaller delta B value is preferred and indicates less encrustation. A difference of 0.5-1.0 delta B units among test formulations in this test is visually perceivable. The validity of these reflectance measurements was confirmed by the data shown in Table 2 where, in addition to reflectance measurements, the washed black cloth swatches were incinerated to a constant weight in order to accurately weigh the amount of inorganic ash present.

Detergency experiments were also conducted in Tergotometers. Detergency experiments were conducted on systems 11-16 only. Four different test cloths were included. Washes were conducted at 90 degrees Fahrenheit in 150 ppm hardness water (3:1 Ca:Mg). Only single 12 minute wash experiments were conducted. Formulations 11-15 were dosed at 0.90 grams per liter. Formulation 16 (commercial benchmark) was dosed at 1.08 grams per liter. Prewash and postwash reflectance measurements (xyz scale) were made on the swatches. The change in reflectance (delta R) was calculated, and the sum of average values of the four test cloths is reported in the tables. A larger delta R value indicates better cleaning performance. The test is a standard laboratory procedure and is typical of those used throughout the industry.

Formulations 1-9 (Table 1) and 11-14 (Table 2) are experimental systems in accordance with the present invention. Formulations 10 (Table 1), 15 and 16 (Table 2) are commercial benchmarks. Formulations 10 and 16 are the same product and represent the U.S. Market standard for detergency and anti-encrustation performance. The formulations, or compositions, for all of the products tested are detailed in Tables 1 and 2. As can be seen from the delta B values in Tables 1 and 2, there are significant differences between the amount of encrustation between the various formulations.

These results clearly demonstrate that in combination with the calcium and magnesium ions in the wash water, the primary source of the encrustation is the carbonate ions from the sodium carbonate. Additionally, these results indicate that the polycarboxylate and the anionic surfactant do not contribute significantly to encrustation since Formulation 15 contains no anionic surfactant as well as a higher level of polycarboxylate yet exhibits the highest delta B value observed. These results are confirmed by the results found for Formulations 4, 5, and 6, which do not incorporate sodium carbonate, but which do incorporate zeolites and layered silicates. As the sodium carbonate increases, the amount of encrustation increases. These latter results also indicate that the remaining components of these compositions do not significantly contribute to the encrustation observed.

The contribution of sodium carbonate to the encrustation observed is also confirmed by a comparison of Formulation 11 with Formulations 12 and 13. It is clear from this comparison that as the amount of sodium carbonate is increased, the degree of encrustation as measured by delta B as well as inorganic ash level is also increased.

Formulations 7, 8, 9, and 11, which incorporate both zeolite and layered silicates, are found to exhibit encrustation levels intermediate to systems primarily built by carbonate (i.e., Formulations 1, 2, 3, and 15) and systems completely free of carbonate (i.e., Formulations 4, 5, and 6). Some calcium and/or magnesium carbonate precipitate is formed due to incomplete or delayed binding of hardness ions by the zeolite and/or the layered silicate. However, the amount of encrustation is not as great as the encrustation found in the formulations where these hardness ion binding agents are absent. The invented compositions provide better performance than compositions without the combination of the zeolite and layered silicates.

Surprisingly, Formulations 12 and 13, both of which also contain a combination of a layered silicate, relatively higher levels of polycarboxylate, and a small amount of zeolite, exhibit the least amount of encrustation as measured by the delta B technique. This result is surprising when realizing that Formulations 12 and 13 each contain a significant amount (i.e., 15%) of sodium carbonate. These formulations exhibit even less color fading than Formulations 4, 5, and 6, which each contain much higher total levels of zeolites and layered silicates while having a complete absence of sodium carbonate. This finding is novel and unexpected.

Additionally, Formulations 12 and 13 exhibit significantly less encrustation than the commercially available product shown as Formulations 10 and 16. The results for this commercially marketed product also demonstrate the potential viability of Formulations 7, 8, and 9. Although these latter compositions exhibit more encrustation than Formulations 10 and 16, the amount of encrustation is not so great as to discount their commercial marketability.

These results are confirmed by the weight percent encrustate as shown in Table 2. The unexpected findings observed via the delta B technique are also found for Formulations 12 and 13. The amount of inorganic residue found for these formulations is significantly less than that of the other compositions evaluated by this technique. Additionally, detergency values shown in Table 2 indicate that each of the six compositions evaluated by this technique provide approximately equivalent cleansing power.

In summary, these results clearly demonstrate that a laundry detergent composition containing a significant level of sodium carbonate can be developed which performs effectively while producing a minimal level of hard water induced encrustation provided that formulation contains an effective total builder composition. Such a total builder composition is based upon the incorporation of an effective level of a layered silicate combined with a limited amount of sodium carbonate, an appropriate amount of polycarboxylate, and optionally a small amount of zeolite in accordance with the present invention. In addition to providing a reduced potential for encrustation, since the compositions described in this document contain low levels of insoluble components (e.g., zeolites), the invented layered silicate based systems are more environmentally friendly because such systems will not contribute significantly to waste stream sludge accumulation.

TABLE 1

| Ingredient | #1 | #2 | #3 | #4 | #5 | #6 | #7 | #8 | #9 | #10 |
|---|---|---|---|---|---|---|---|---|---|---|
| Sodium carbonate | 75.0 | 50.0 | 25.0 | 0.0 | 0.0 | 0.0 | 15.0 | 15.0 | 15.0 | na |
| Zeolite 4A | 0.0 | 0.0 | 0.0 | 25.0 | 50.0 | 25.0 | 5.0 | 30.0 | 5.0 | na |
| SKS-6 | 0.0 | 0.0 | 0.0 | 50.0 | 25.0 | 25.0 | 30.0 | 5.0 | 30.0 | na |
| Nonionic surfactant | 6.0 | 6.0 | 6.0 | 6.0 | 6.0 | 6.0 | 6.0 | 6.0 | 6.0 | na |
| Anionic surfactant | 4.0 | 4.0 | 4.0 | 4.0 | 4.0 | 4.0 | 4.0 | 4.0 | 4.0 | na |
| Polyacrylate | 2.0 | 2.0 | 2.0 | 2.0 | 2.0 | 2.0 | 2.0 | 2.0 | 3.0 | na |
| Sodium sulfate | 10.0 | 35.0 | 60.0 | 10.0 | 10.0 | 35.0 | 35.0 | 35.0 | 34.0 | na |
| Water/miscellaneous | 3.0 | 3.0 | 3.0 | 3.0 | 3.0 | 3.0 | 3.0 | 3.0 | 3.0 | na |
| Δ blackness | 5.13 | 4.59 | 3.79 | 1.92 | 1.86 | 1.94 | 3.30 | 3.60 | 2.72 | 2.38 |
| Weight % encrustate | na | na | na | na | na | na | na | na | na | na |

TABLE 2

| Ingredient | #11 | #12 | #13 | #14 | #15 | #16 |
|---|---|---|---|---|---|---|
| Sodium carbonate | 20.0 | 15.0 | 15.0 | 36.0 | 75.5 | na |
| Zeolite 4A | 5.0 | 5.0 | 5.0 | 20.0 | 0.0 | na |
| SKS-6 | 25.0 | 30.0 | 25.0 | 0.0 | 0.0 | na |
| Nonionic surfactant | 15.0 | 15.0 | 15.0 | 15.0 | 15.0 | na |
| Anionic surfactant | 0.0 | 0.0 | 0.0 | 0.0 | 0.0 | na |
| Polyacrylate | 4.0 | 4.0 | 4.0 | 2.5 | 4.0 | na |
| Sodium sulfate | 30.4 | 30.4 | 35.4 | 25.9 | 0.0 | na |
| Protease | 0.6 | 0.6 | 0.6 | 0.6 | 0.6 | na |
| Water/miscellaneous | 0.0 | 0.0 | 0.0 | 0.0 | 4.9 | na |
| Δ blackness | 3.85 | 1.26 | 0.96 | 5.47 | 7.61 | 2.60 |
| Weight % encrustate | 2.30 | 1.12 | 1.16 | 4.06 | 5.85 | 2.03 |
| Δ reflectance | 46.01 | 48.32 | 46.12 | 47.36 | 45.97 | 45.32 |

The foregoing description of the specific embodiments will so fully reveal the general nature of the invention that others can, by applying current knowledge, readily modify and/or adapt for various applications such specific embodiments without departing from the generic concept and, therefore, such adaptations and modifications should and are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A laundry detergent composition comprising:
from about 5 to about 40% by weight of surfactant or surfactant mixture;
from about 10 to about 50% by weight of layered silicate;
from about 0 to about 10% by weight of zeolite;
from about 5 to about 30% by weight of carbonate and/or bicarbonate salt;
from 1 to about 15% by weight of salts of polycarboxylic acids or mixtures or salts of polycarboxylic acids; and
from 0 to about 70% by weight of additional inorganic salts.

2. A laundry detergent composition according to claim 1 further comprising from about 0 to about 30% by weight of at least one additive selected from a soil-release compound, a soil redeposition inhibitor, a foam inhibitor, a fragrance, a dye, a fabric softener, enzyme, a bleaching agent, a bleaching agent activator, a wrinkle reduction agent, an optical brightener, a disintegration aide and mixtures thereof.

3. A laundry detergent composition according to claim 1 wherein said surfactant is selected from nonionic surfactants, anionic surfactants and mixtures thereof.

4. A laundry detergent composition according to claim 1 wherein said surfactant is selected from carboxylates, sulfonates, sulfates, soaps of natural fatty acids, soaps of fatty acid mixtures, polyoxyethylene surfactants, carboxylic acid esters, natural ethoxylated fats, natural ethoxylated oils, natural ethoxylated waxes, glycol esters of fatty acids, alkylpolyglycosides, carboxylic amides, fatty acid glucamides, polyalkylene oxide block copolymers and poly(oxyethylene-co-oxypropylene) nonionic surfactants and mixtures thereof.

5 A laundry detergent composition according to claim 1 wherein said layered silicate is selected from β-sodium disilicate and δ-sodium disilicate.

6 A laundry detergent composition according to claim 1 wherein said zeolite is selected from chabazite, mordenite, erionite, faujasite, clinoptilolite, phillipsite, zeolite A, zeolite X, zeolite Y, zeolite L, zeolite P, zeolite omega and ZSM-5.

7. A laundry detergent composition according to claim 1 wherein said polycarboxlate is selected from homo- and co-polymers of acrylate and/or maleate salts and polymeric acids thereof.

8. A laundry detergent composition according to claim 2 wherein said redeposition inhibitor is selected from a polymeric carboxylic acid, a water soluble salt of said polymeric carboxylic acid, ether carboxylic acid, an ether sulfonic acid of starch, a salt of said ether sulfonic acid of starch, an ether sulfonic acid of cellulose, a salt of said ether sulfonic acid of cellulose, a sulfuric acid ester of cellulose, a salt of said sulfuric acid ester of cellulose, a sulfuric acid ester of starch, a salt of said sulfuric acid ester of starch, a water-soluble polyamide containing acidic groups, a soluble starch preparation and polyvinyl pyrrolidone.

9. A laundry detergent composition according to claim 2 wherein said foam inhibitor is selected from a natural or synthetic soap having a high percentage content of C₁₈-₂₄ fatty acids, an organopolysiloxane and mixtures thereof with silanized silica, a paraffin and a wax.

10. A laundry detergent composition according to claim 2 wherein said enzymes are selected from proteases, lipases, amylases, cellulases and mixtures thereof.

11. A laundry detergent composition according to claim 2 wherein said optical brightener is selected from derivatives of diaminostilbene disulfonic acid and alkali metal salts thereof.

12. A laundry detergent composition according to claim 2 wherein said bleaching agent is selected from inorganic peroxygen liberating agent, peroxygen activator, peroxyacid and mixtures thereof.

13. A laundry detergent composition according to claim 12 wherein said inorganic peroxygen liberating agent is selected from sodium perborate and sodium percarbonate, wherein said peroxygen activator is selected from tetra acetylethylenediamine (TAED) and nonanoyl oxybenzene sulfonate (NOBS), and wherein said peroxyacid is selected from pthalimidoperhexanoic acid (PAP).

14. A laundry detergent composition according to claim 2 wherein said disintegration agent is selected from readily water-soluble materials, effervescent materials, readily water-swellable materials and mixtures thereof.

15. A laundry detergent composition according to claim 14 wherein said readily water-soluble material is sodium acetate, wherein said effervescent material is a combination of sodium bicarbonate and sodium citrate, and wherein said water-soluble material is selected from suitable starches, cellulosics, specialty polymers including suitable polycarboxylates, and polyvinylpyrrolidone (PVP) and mixtures thereof.

16. A laundry detergent composition comprising:
from about 5 to about 30% by weight of surfactant or surfactant mixture;
from about 20 to about 40% by weight of a layered silicate;
from about 0 to about 5% by weight of a zeolite;
from about 5 to about 20% by weight of a salt of carbonate and/or bicarbonate;
from about 1 to about 10% by weight of a salt of a polycarboxylic acid or mixture of salts of polycarboxylic acids; and
from about 0 to about 70% by weight of fillers including inorganic salts.

17. A laundry detergent composition according to claim 16 further comprising from about 0 to about 30% by weight of at least one additive selected from a soil-release compound, a redeposition inhibitor, a foam inhibitor, a fragrance, a dye, a fabric softener, enzyme, a bleaching agent, a bleaching agent activator, a wrinkle reduction agent, an optical brightener, a disintegration aide and mixtures thereof.

18. A laundry detergent composition according to claim 16 wherein said surfactant is selected from nonionic surfactants, anionic surfactants and mixtures thereof.

19. A laundry detergent composition according to claim 16 wherein said surfactant is selected from carboxylates, sulfonates, sulfates, soaps of natural fatty acids, soaps of fatty acid mixtures, polyoxyethylene surfactants, carboxylic acid esters, natural ethoxylated fats, natural ethoxylated oils, natural ethoxylated waxes, glycol esters of fatty acids, alkylpolyglycosides, carboxylic amides, fatty acid glucamides, polyalkylene oxide block copolymers and poly(oxyethylene-co-oxypropylene) nonionic surfactants and mixtures thereof.

20. A laundry detergent composition according to claim 16 wherein said layered silicate is selected from β-sodium disilicate and δ-sodium disilicate.

21. A laundry detergent composition according to claim 16 wherein said zeolite is selected from chabazite, mordenite, erionite, faujasite, clinoptilolite, phillipsite, zeolite A, zeolite X, zeolite Y, zeolite L, zeolite P, zeolite omega and ZSM-5.

22. A laundry detergent composition according to claim 16 wherein said polycarboxylate is selected from homo- and co-polymers of acrylate and/or maleate salts and polymeric acids thereof.

23. A laundry detergent composition according to claim 17 wherein said soil redeposition inhibitor is selected from a polymeric carboxylic acid, a water soluble salt of said polymeric carboxylic acid, ether carboxylic acid, an ether sulfonic acid of starch, a salt of said ether sulfonic acid of starch, an ether sulfonic acid of cellulose, a salt of said ether sulfonic acid of cellulose, a sulfuric acid ester of cellulose, a salt of said sulfuric acid ester of cellulose, a sulfuric acid ester of starch, a salt of said sulfuric acid ester of starch, a water-soluble polyamide containing acidic groups, a soluble starch preparation and polyvinyl pyrrolidone.

24. A laundry detergent composition according to claim 17 wherein said foam inhibitor is selected from a natural or synthetic soap having a high percentage content of C₁₈₋₂₄ fatty acids, an organopolysiloxane and mixtures thereof with silanized silica, a paraffin and a wax.

25. A laundry detergent composition according to claim 17 wherein said enzymes are selected from proteases, lipases, amylases, cellulases and mixtures thereof.

26. A laundry detergent composition according to claim 17 wherein said optical brightener is selected from derivatives of diaminostilbene disulfonic acid and alkali metal salts thereof.

27. A laundry detergent composition according to claim 17 wherein said bleaching agent is selected from inorganic peroxygen liberating agent, peroxygen activator, peroxyacid and mixtures thereof.

28. A laundry detergent composition according to claim 27, wherein said inorganic peroxygen liberating agent is selected from sodium perborate and sodium percarbonate, wherein said peroxygen activator is selected from tetra acetylethylenediamine (TAED) and nonanoyl oxybenzene sulfonate (NOBS), and wherein said peroxyacid is selected from pthalimidoperhexanoic acid (PAP).

29. A laundry detergent composition according to claim 17 wherein said disintegration agent is selected from readily water-soluble materials, effervescent materials, readily water-swellable materials and mixtures thereof.

30. A laundry detergent composition according to claim 29 wherein said readily water-soluble material is sodium acetate, wherein said effervescent material is a combination of sodium bicarbonate and sodium citrate, and wherein said water-soluble material is selected from suitable starches, cellulosics, specialty polymers including suitable polycarboxylates, and polyvinylpyrrolidone (PVP) and mixtures thereof.
